(19) United States
(12) Patent Application Publication
(10) Pub. No.: US 2010/0058973 A1
(43) Pub. Date: Mar. 11, 2010

(54) CONTROL AND/OR MONITORING METHOD FOR THE SALTING-OUT OF AT LEAST ONE ACTIVE INGREDIENT IMPREGNATED IN A TEXTILE

(75) Inventor: Sophie Beauge-Duguet, Restigne (FR)

Correspondence Address: CANTOR COLBURN, LLP, 20 Church Street, 22nd Floor, Hartford, CT, 06103, US

(73) Assignee: SKIN'UP, RESTIGNE (FR)

(21) Appl. No.: 12/514,333

(22) PCT Filed: Nov. 15, 2007
(86) PCT No.: PCT/FR07/01877

§ 371 Date: Jul. 6, 2009

(30) Foreign Application Priority Data
Nov. 15, 2006 (FR) 0609999

(51) Int. Cl. G01D 21/00

(52) U.S. Cl. 116/201; 116/206

(57) ABSTRACT

A control and/or monitoring method for the salting-out of at least one active ingredient impregnated in a first textile material characterized in that: a) said first textile material impregnated with said at least one active ingredient is provided, b) a control tag is affixed on the first textile material, and is made from a second textile material at least partially impregnated with a dye, the quantity of which being adjusted in such a way that the discoloration of said tag is proportional to the salting-out of said at least one active ingredient, c) the quantity of the at least one salted-out active ingredient is evaluated by visualizing the discoloration of the said tag. The invention relates to a control and/or monitoring tag of the salting-out of at least one active ingredient impregnated into a textile material.

### FIELD OF THE INVENTION

The present invention relates to the monitoring of the exhausting and/or release of active principles which are impregnated in textiles.

### BACKGROUND OF THE INVENTION

Multiple applications of impregnated textiles which make possible the release or the administration of active principles have been developed since the 1990s.

Mention may in particular be made, by way of illustration, of scarves impregnated with fragrance, impregnated “wipes” for hygiene and/or cleansing, or furnishing textiles (such as curtains and/or bed linen) which release insecticides and/or acaricides.

Applications combining clothing and cosmetics have now been added to this list of applications which is enumerated above. Thus, clothes have been created which are composed of fibers capable of releasing active principles, such as slimming agents or moisturizing agents, essential oils, vitamins or indeed even deodorant products.

Furthermore, such applications are also known in the pharmaceutical field, with dressings comprising healing or antimicrobial agents.

The applications of these textiles impregnated with active principles are therefore highly varied. However, they all have the distinctive feature of confronting the user of these textiles with the same problem, which is of not being able to easily monitor if the textile is still sufficiently impregnated with active principles or if, on the contrary, reimpregnation of the textile with said active principles proves to be necessary due to their highly advanced release.

This is because the rate of release of said active principles can vary according to the conditions of use and the number of washing operations carried out on the textile impregnated with active principles. Mention may be made, by way of example, of the case of furnishing fabrics, the active principles with which they are impregnated being released in multiple ways:

as a result of the random exposure of these fabrics to the air or to the sun (conditions of use),

as a result of the treatments, such as washing, to which these fabrics are subjected.

Thus, for this reason, it is difficult to indicate, to the user, a precise “lifetime” for his impregnated textile since it is greatly influenced by the abovementioned parameters.

In the field of impregnated textiles, a method which makes it possible to characterize the amount of active principles, as a function of the number of washing operations and of the washing conditions, is certainly known. It consists in chemically analyzing, after an extraction, the amount of active principles remaining after each washing operation on the impregnated textile. A remaining percentage of the active principles is thus calculated with respect to the initial amount impregnated in the textile.

Thus, with this method, the user of the impregnated textile can be informed of a calibration indicating the remaining amount of active principles as a function of the number of washing operations which have been carried out is and can thus judge the need to carry out a reimpregnation of the textile as a result of the release, already highly advanced, of the active principles.

However, this method has the following disadvantages:

it takes into account only the release of the active principles by the washing operations and does not take into account the real conditions of use of the impregnated textile, which can be highly diverse, depending on the user, during which the active principles can also be released,

conditions for washing the impregnated textile which are employed by the user, which are not necessarily identical to those which were employed in carrying out the calibration and, finally,

it requires the user of the impregnated textile to have to keep count of the number of washing operations carried out.

### BRIEF DESCRIPTION OF THE INVENTION

The present invention makes it possible to overcome the disadvantages listed above. This is because it provides a method for monitoring the release of active principles impregnated in a textile which is within the scope of the user.

The present invention relates to a method for monitoring and/or following the release of at least one active principle impregnated in a first textile, characterized in that:
a) there is available said first textile impregnated with said at least one active principle,
b) there is available a monitoring label attached to said first textile and made of a second textile at least partially impregnated with a colorant, the amount of which is adjusted so that the decolorization of said label is proportional to the release of said at least one active principle,
c) the amount of the at least one active principle released is evaluated by observation of the decolorization of said label.

In this way, the user can follow the exhaustion of the textile in active principle by simple visual monitoring of the decolorization of the monitoring label and can therefore decide:
on the need to recharge by spraying said textile,
to affix a new label, which can be supplied with the container of the recharge emulsion or else which is produced directly by the user by spraying the colorant over the textile fibers constituting a new monitoring label.

The method according to the invention can thus comprise an additional stage which consists, after having observed a partial or complete decolorization of said monitoring label, in spraying said at least one active principle over said first textile. It is also then possible to affix a new monitoring label to said first textile.

This monitoring method exhibits the advantage of avoiding untimely rechargings which can prove to be dangerous and can result in the at least one active principle being charged in excessive amounts. This method also takes into account the conditions of use, such as the exposure to an environment, and also the washing conditions.

### DETAILED DESCRIPTION OF THE PREFERRED EMBODIMENTS

The first textile and the monitoring label used in the method according to the invention are identical or different textiles which can be chosen from nonwoven, woven or knitted textiles. These textiles are composed of fibers which can be natural or synthetic, indeed can even be a mixture of these.

The natural fibers are chosen from cotton, wool, silk and/or jute.

The synthetic fibers are chosen from polyamides, polyesters, polyacrylonitriles, polyolefins, such as polypropylene or polyethylene, or Teflon.

The fibers can be spun, carded or twisted.

The monitoring label is attached to the first textile. It can, for example, be stitched to a portion of said first textile.

As stated above, the amount of colorant is adjusted so that the decolorization of said label is proportional to the release of said at least one active principle.

To achieve this, precise adjusting of the amount of colorant impregnated in the monitoring label is essential. This adjusting will also depend on the nature of the textile fibers of the monitoring label, which can influence the rate of release of the colorant.

The amount of colorant will thus be appropriate, taking into account the washing operations and the conditions of use of the textile.
Thus, it will be possible, in order to carry out this adjusting, for example, to carry out tests in which the release of the at least one active principle is followed in parallel with that of the colorant with which the monitoring label is impregnated. These tests in which the release is followed will have the aim of simulating as best as possible the conditions of use of the textile impregnated with at least one active principle.
For example, these tests can simulate the conditions under which an item of clothing is worn or else can simulate the environmental conditions to which furnishing fabrics or curtains may be subjected.

Specifically, the textile for which the monitoring and/or the following of the release of at least one active principle is intended can be an item of clothing, gloves, slippers, underwear, stockings or pantyhose, but also curtains, cushion or sofa covers, or wall textiles, or else medical articles, such as bandages, splints or dressings but also compresses, head bandages or masks.

The at least one active principle can be chosen from pharmaceutical or cosmetic active principles, deodorizing agents, insecticides or acaricides.

In the present invention, the at least one active principle can be chosen from slimming, refreshing or moisturizing active principles.

The at least one active principle can be lipophilic or hydrophilic.

Mention may be made, among lipophilic active principles, of:

fat-soluble vitamins and their derivatives, such as the family of the retinoids, for example retinol, retinaldehyde or retinoic acid, of the carotenoids, or tocopherol and its derivatives,

polyphenols, such as flavonoids, for example isoflavonoids, quercetin, stilbenes, for example resveratrol, or catechins, for example epicatechin 3-gallate or epigallocatechin 3-gallate,

perfumery components, such as vanillin, indole or more generally essential oils, such as essential oils of citrus fruits or of lavender,

fat-soluble pharmaceutical active principles, such as fluvastatin, ketoprofen, verapamil, atenolol, griseofulvin or ranitidine.

The hydrophilic active principles can be chosen from aminoglucosides (gentamicin), antibiotics (β-lactam, sulbenicillin, cefotiam, cefmenoxime), peptide hormones (TRH, leuprolide, insulin), antiallergic, to antimycotic or cytostatic agents, anxiolytics, contraceptives, sedatives, mineral salts (calcium, chlorine, magnesium, phosphorus, potassium, sodium, sulfur), trace elements (aluminum, bromine, copper, cobalt, iron, fluorine, manganese, molybdenum, iodine, selenium, silicon, vanadium, zinc), amino acids (alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine), peptides, proteins, water-soluble vitamins, polyols, or indeed even flavorings.

In a specific form of the invention, when the monitoring label is intended to follow the exhaustion of an active principle impregnated in an item of clothing, the colorant with which the monitoring label is impregnated can be chosen from the list of colorants which may be present in cosmetic products drawn up in Annex IV of Directive 76/768/EEC. Thus, should the monitoring label be in contact with the skin, there will be no risk of toxicity.

The at least one active principle can be in the form of nanoparticles or of microparticles or else in solution.

The colorant can be in the form of nanoparticles or of microparticles or else in solution.

The at least one active principle and the colorant can be in identical or different forms.

In one embodiment of the invention, the at least one active principle and/or the colorant can be in the form of microparticles which can be chosen from microcapsules or microemulsions.

In one embodiment of the invention, the at least one active principle and/or the colorant can be in the form of nanoparticles, the size of which is less than 300 nm (0.3 μm), on average 150 nm.

Mention may in particular be made, among the nanoparticles which can be used in the present invention, of titanium dioxide, zinc oxide, fullerenes, nanocrystals (also known as quantum dots; namely semiconducting crystals) and nanoemulsions, nanocapsules, nanospheres, nanovesicles or spherulites.

As regards the nanoparticles in the nanoemulsion form, they can be obtained by any process known to a person skilled in the art which makes it possible to produce emulsions. In this respect, reference may be made to formulatory works, such as “Pharmacie Galénique” [Formulatory Pharmaceutical Science], A. Le Hir, published by Masson (8th edition of 2006).

Furthermore, the nanoparticles can also be obtained by the processes described in patent applications EP 0 717 989 A1, WO 2000/71676 A1, WO 2001/64328 A1 and WO 2004/060358 A2.

Patent application WO 2004/060358 A2 specifically describes a process for the preparation of PIT emulsion.

The textile and the monitoring label are respectively impregnated is with the at least one active principle and with the colorant by any technique known in the field of textiles, such as, for example, by dipping, exhaustion bath, spraying or padding.

When the at least one active principle is in the form of nanoparticles, the amount of nanoparticles can be between 10 and 50 g per kg of textile.

In a preferred embodiment of the invention, the impregnation is carried out by dipping at a temperature of between 20° C. and 60° C.

As regards the textile, in addition to the compound of interest and/or active principle, the aqueous solution in which the dipping of the textile is carried out can comprise other additives, such as those chosen from preservatives and/or antibacterials, fillers, antifoaming agents, antistatic agents, stabilizers, antioxidants and/or UV screening agents. The aqueous solution can also comprise flame retardants, plasticizers, pigments and agents which make possible the formation of a protective sheath around the fibers of which the textile is composed, which protective sheath slowly disintegrates on contact with the subject wearing the textile.

The invention also relates to a label for monitoring and/or following the release of at least one active principle impregnated in a first textile, said label being made of a second textile which is impregnated with a colorant, the amount of which is adjusted so that the decolorization of said label is proportional to the release of said at least one active principle.

The invention also relates to a textile article comprising a monitoring label as described above.

The textile article can be chosen from items of clothing, gloves, slippers, underwear, stockings, pantyhose, curtains, cushion or sofa covers, wall textiles, bandages, splints, dressings, compresses, head bandages or masks.

The following examples illustrate the invention without, however, limiting the scope thereof.

### EXAMPLES

The experimental part is composed of three parts illustrating the present invention:

1) The preparation of a monitoring label and the monitoring of the release of the colorant with which said monitoring label is impregnated, as a function of the washing operations carried out and as a function of the diluting of the colorant solution carried out before the impregnation of the monitoring label.

2) The development of a method for extracting a slimming active principle, sterol, in order to be able to precisely determine the remaining amount of this active principle impregnated in the textile after multiple washing operations carried out.

3) The determination of the appropriate monitoring label which is proportional to the release of a microencapsulated fragrance with which a textile is impregnated.

### Example 1

1) Preparation of a monitoring label:

The impregnation protocol for the preparation of a monitoring label was as follows.

The operation was carried out on monitoring labels made of white textile fibers (as 100% polyamide, nonwoven). Nature of the colorant: a white solid which, dissolved, gives a pink solution, of CAS number: 13473-26-2, and with the chemical structure:

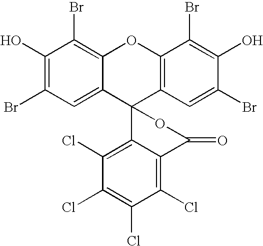

The colorant was in the form of a nanoemulsion obtained according to the process described in WO 2004/060358 A2.

The amount of colorant present in the nanoemulsion was 0.25 g per 100 g of nanoemulsion.

The nanoemulsion was diluted in water according to a given concentration: ½ or ¼ or ⅛ or 1/16.

The monitoring labels were immersed at 40° C. in one of the abovementioned is dilute solutions.

The impregnation time was 30 minutes. Drying was carried out in a flat position.

Once dried, the various labels were washed up to 20 times, this being carried out according to the standardized protocol of the standard ISO 6330 (standard relating to methods for domestic washing and drying for the purpose of tests on textiles).

After each washing and drying, the color of the label was given a numerical value.

The results obtained are summarized in the following table 1.

The following colors were defined:
Fuchsia pink,
Fuchsia pink 2 (Lighter pink than Fuchsia pink)
Pink,
Light pink,
Light pink 2 (Lighter pink than Light pink),
Pastel pink,
Pastel pink 2 (Lighter pink than Pastel pink),
Pinkish white.

TABLE 1
Decolorization of the monitoring labels as a function of the
dilution of the coloring solution and of the number of
washing operations carried out

| Number of | | | | |
|---|---|---|---|---|
| washing | | | | |
| operations | ½ Dilution | ¼ Dilution | ⅛ Dilution | 1/16 Dilution |
| Control | Fuchsia pink | Fuchsia | Pink | Light pink |
| | | pink 2 | | |
| 1 Washing | Pink | Pink | Light pink | Light pink |
| operation | | | | |
| 3 Washing | Light pink | Light pink | Light pink | Light pink |
| operations | | | | |
| 5 Washing | Light pink 2 | Light pink 2 | Light pink | Light pink |
| operations | | | | |
| 7 Washing | Pastel pink | Pastel pink | Light pink | Pastel pink |
| operations | | | | |
| 10 Washing | Pastel pink 2 | Pastel pink 2 | Pastel pink | Pastel pink |
| operations | | | | |
| 15 Washing | Pastel pink 2 | Pastel pink 2 | Pinkish | Pinkish white |
| operations | | | white | |
| 20 Washing | Pastel pink 2 | Pastel pink 2 | Pinkish | Pinkish white |
| operations | | | white | |

### Example 2

2) Development of a method for the extraction and analysis of a slimming active principle: the sterol.

The sterol was in the form of a nanoemulsion obtained according to the process described in WO 2004/060358 A2.

The sterol was quantitatively determined by reverse-phase liquid chromatography with detection in the ultraviolet at 240 nm. The linearity of the quantitative determination of the sterol in pure solution was confirmed with sterol solutions prepared from the source of the sterol, namely rhodysterol (red alga extract known for its excellent lipolytic properties).

The reagents were as follows:
rhodysterol (Batch 6.06.171),
a slimming mist SYO1 92V—Placebo (from Cosnessens),
a slimming mist SY0192V—comprising 5% of active principle (from Cosnessens),
a slimming mist SYO192X—comprising 2% of active principle (from Cosnessens),
methanol for chromatography (from VWRI),
absolute ethanol for analysis (Carlo Erba).

The chromatography conditions were as follows:
stationary phase: column Supelcosil LC18, 5 pm, 250×4.6 mm,
mobile phase: methanol,
UV detection: 240 nm,
flow rate: 1.0 ml/min.

The amount injected was 20 μl.

The analytical time was 30 minutes.

The retention times (depending on its specific conditions) were 12.5 minutes.

Preparation of the solutions:

A sterol mother solution for the quantitative determination (hereinafter abbreviated to MS) was prepared in the following way:
A sample W_{C} of approximately 500 mg of mist comprising sterol at 0.075% was introduced, with accuracy, into a 50 ml volumetric flask, dissolved in approximately 40 ml of ethanol and made up to volume with the same solvent. A control Quantitative determination solution was prepared by transferring 2.0 ml of the mother solution (MS) into a 10 ml volumetric flask and making up to the graduation line with absolute ethanol.

A test solution was prepared by introducing half of a pair of shorts (with a weight W_{T} in grams) in well-packed fashion into the bottom of a 1000 ml flask, and also a magnetic bar.

500 ml, exactly measured, of absolute ethanol were added to the flask, which was subsequently placed under ultrasound for 30 minutes and then stirred magnetically for 20 minutes.

The operations employing ultrasound and magnetic stirring were repeated three times.

An exactly measured amount of 100 ml of the liquid obtained was withdrawn and evaporated to dryness under vacuum at a temperature of approximately 40° C.
The evaporation residue was dissolved in 5 ml of absolute ethanol and then filtered through a filter with a porosity of 0.45 μm.

Two injections of 20 μl of the control solution were carried out in order to calculate the mean of the sterol peak areas, i.e. Aₐ.

Two injections of 20 μl of the test solution were carried out in order to calculate the mean of the sterol peak areas, i.e. A_{T}.

The sterol content, expressed in mg per unit of shorts, is calculated according to the formula:

$$Q = \frac{{A}_{T}}{{A}_{a}} * \frac{2 * 0.075 * {W}_{c}}{50 * 5 * 100} * \frac{WW}{{W}_{T}} * \frac{500 * 5}{100}$$

A_{T}: is the mean of the sterol peak areas in the test solution,

Aₐ: is the mean of the sterol peak areas in the control solution,

W_{C}: is the sample in mg of the mist comprising 0.075% of sterol,

W_{T}: is the sample in g of shorts,

WW: is the weight in g of the shorts.

Thus, the following quantitative determination was carried out:

WW=50.22212 g

W_{T}=24.86049 g

W_{C}=514 mg

The following peak areas were found:

A_{T}=48470

Aₐ=61928

The content (Q) of sterol was thus as follows:

$$\begin{matrix}The content Q = \frac{48470}{61928} \times \frac{2 \times 0.075 \times 514}{50 \times 5 \times 100} \times \frac{50.22212}{24.66049} \times \frac{500 \times 5}{100} \\ = 0.123 mg \text{/} shorts\end{matrix}$$

Furthermore, the specificity of the quantitative determination of the sterol was confirmed by comparing the chromatograms:
of a control solution of mist devoid of sterol (1),
of a control solution of mist comprising sterol (2),
of a control solution of rhodysterol (3),
of a sample solution obtained after extraction (4).

In the last three solutions, a well-isolated peak with a retention time of the order of 12.5 minutes characteristic of the presence of sterol was indeed encountered.

This thus clearly validated the idea of carrying out the extraction of the sterol by liquid chromatography.

Furthermore, the linearity of the method was confirmed by quantitatively determining the sterol starting from four solutions prepared from rhodysterol.

### Example 3

The example below illustrates the exhaustion by washing of microencapsulated compounds of interest and/or active principles attached to cotton fibers and/or textiles.

The compound of interest was a fragrance: linalyl acetate (main compound of lavender), of CAS number: 115-95-7 and with the chemical structure:

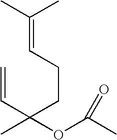

In order for the fragrance to be released from the capsules attached to the fibers, extraction was carried out by accelerated solvent extraction (ASE) with a Dionex device. The solvent chosen was acetone. ASE uses a high pressure and high temperature process which makes it possible to split the membrane of is the capsules and to extract the linalyl acetate. A gas chromatography procedure was then developed in order to be able to quantify the linalyl acetate extracted. The extraction and analytical methods were carried out on the textile, before and after each washing operation.

The following results were obtained:

TABLE 2
Percentage of fragrance extracted from the textile

| Number of washing operations | % Fragrance |
|---|---|
| Control | 100 |
| 1 Washing operation | 70 |
| 3 Washing operations | 60 |
| 5 Washing operations | ≈50 |
| 7 Washing operations | ≈40 |
| 10 Washing operations | 35 |

Among the monitoring labels prepared in example 1, it may be noticed, in the following table 3, that the monitoring label prepared with a ½ dilution follows a decolorization similar to the change in the percentage of fragrance extracted from the textile.

TABLE 3
Comparison of % active principle/decolorization as a function
of the number of washing operations

| Number of washing | | |
|---|---|---|
| operations | ½ Dilution | % Fragrance |
| Control | Fuchsia pink | 100 |
| 1 Washing operation | Pink | 70 |
| 3 Washing operations | Light pink | 60 |
| 5 Washing operations | Light pink 2 | ≈50 |
| 7 Washing operations | Pastel pink | ≈40 |
| 10 Washing operations | Pastel pink 2 | 35 |

Thus, the monitoring label prepared with ½ dilution might be entirely suitable as monitoring label in the textile impregnated with linalyl acetate microcapsules.

1. A method for monitoring and/or following a release of at least one active principle impregnated in a first textile, comprising:
a) providing said first textile impregnated with said at least one active principle,
b) providing a monitoring label attached to said first textile and
made of a second textile at least partially impregnated with a colorant, an amount of which is adjusted so that a decolorization of said label is proportional to a release of said at least one active principle,
c) evaluating an amount of the at least one active principle released by observation of the decolorization of said label.

2. The method as claimed in claim 1, wherein said first and second textiles are chosen from the group comprising nonwoven, woven or knitted textiles.

3. The method as claimed in claim 1, wherein said first textile comprises at least one of an item of clothing, gloves, slippers, underwear, stockings, pantyhose, curtains, cushion or sofa covers, wall textiles, bandages, splints, dressings, compresses, head bandages or masks.

4. The method as claimed in claim 1, wherein the at least one active principle comprises at least one of pharmaceutical or cosmetic active principles, deodorizing agents, insecticides or acaricides.

5. The method as claimed in claim 4, wherein the at least one active principle is a slimming, refreshing or moisturizing active principle.

6. The method as claimed in claim 1, wherein the at least one active principle comprises at least one of fat-soluble vitamins and their derivatives, polyphenols, stilbenes, catechins, vanillin, indole, essential oils, fluvastatin, ketoprofen, verapamil, atenolol, griseofulvin, ranitidine, aminoglucosides, antibiotics, peptide hormones, antiallergic, antimycotic or cytostatic agents, anxiolytics, contraceptives, sedatives, mineral salts, trace elements, amino acids, peptides, proteins, water-soluble vitamins, polyols or flavorings.

7. The method as claimed in claim 1, wherein said colorant is chosen from the list of colorants drawn up in Annex IV of Directive 76/768/EEC.

8. The method as claimed in claim 1, wherein said at least one active principle is in a form nanoparticles or of microparticles or else in solution.

9. The method as claimed in claim 1, wherein said colorant is in a form of nanoparticles or of microparticles or else in solution.

10. The method as claimed in claim 8, wherein said nanoparticles have a size of less than 300 nm.

11. The method as claimed in claim 8, wherein said nanoparticles comprise at least one of titanium dioxide, zinc oxide, fullerenes, nanocrystals, nanoemulsions, nanocapsules, nanospheres, nanovesicles or spherulites.

12. The method as claimed in claim 8, wherein the microparticles comprise microcapsules or microemulsions.

13. The method as claimed in claim 1, wherein the impregnation of said first and second textiles comprises dipping, exhaustion bath, spraying or padding.

14. The method as claimed in claim 1, wherein the impregnation is carried out by dipping at a temperature of between 20° C. and 60° C.

15. The method as claimed in claim 1, wherein, when the at least one active principle is in a form of nanoparticles, an amount of nanoparticles is between 10 and 50 g per kg of textile.

16. A label for monitoring and/or following a release of at least one active principle impregnated in a first textile, wherein said label is made of a second textile which is impregnated with a colorant, an amount of which is adjusted so that a decolorization of said label is proportional to the release of said at least one active principle.

17. A textile article, comprising a label as claimed in claim 16.

18. The textile article as claimed in claim 17, wherein the article comprises at least one of clothing, gloves, slippers, underwear, stockings, pantyhose, curtains, cushion or sofa covers, wall textiles, bandages, splints, dressings, compresses, head bandages or masks.

19. The method as claimed in claim 1, further comprising, spraying said at least one active principle over said first textile after having observed a partial or complete decolorization of said label.

20. The method as claimed in claim 19, further comprising affixing a new label for monitoring and/or following a release of at least one active principle impregnated in a first textile, wherein said label is made of a second textile which is impregnated with a colorant, an amount of which is adjusted so that a decolorization of said label is proportional to the release of said at least one active principle.

21. The method as claimed in claim 9, wherein said nanoparticles have a size of less than 300 nm.

22. The method as claimed in claim 9, wherein said nanoparticles are chosen from the group comprising titanium dioxide, zinc oxide, fullerenes, nanocrystals, nanoemulsions, nanocapsules, nanospheres, nanovesicles or spherulites.

23. The method as claimed in claim 9, wherein the microparticles are chosen from microcapsules or microemulsions.
